(19) United States
(12) Patent Application Publication
(10) Pub. No.: US 2024/0311225 A1
(43) Pub. Date: Sep. 19, 2024

(54) SYSTEM, METHOD, AND STORAGE MEDIUM

(71) Applicant: Yutaka Matsumura, Kanagawa (JP)

(72) Inventor: Yutaka Matsumura, Kanagawa (JP)

(73) Assignee: Ricoh Company, Ltd., Tokyo (JP)

(21) Appl. No.: 18/591,529

(22) Filed: Feb. 29, 2024

(30) Foreign Application Priority Data
Mar. 16, 2023 (JP) 2023-042293
Nov. 7, 2023 (JP) 2023-190067

(51) Int. Cl. G06F 11/07

(52) U.S. Cl. CPC G06F 11/079

(57) ABSTRACT

A system predicts an abnormality of a first device. The system includes processing circuitry. The processing circuitry calculates a first increment value of a number of uses of the first device included in a first apparatus, based on a first total number of uses of the first device within a first predetermined period. The processing circuitry determines an abnormality of the first device based on the first increment value.

### CROSS-REFERENCE TO RELATED APPLICATIONS

This patent application is based on and claims priority pursuant to 35 U.S.C. § 119(a) to Japanese Patent Application No. 2023-042293, filed on Mar. 16, 2023, and No. 2023-190067, filed on Nov. 7, 2023, in the Japan Patent Office, the entire disclosure of which is hereby incorporated by reference herein.

### BACKGROUND

### Technical Field

Embodiments of the present disclosure relate to a system, a method, and a storage medium. The system, the method, and the storage medium each detect a predictor of an occurrence of an abnormality.

### Related Art

As technologies become more sophisticated and diverse, predictions of abnormalities in various devices are becoming more important. For example, in an image forming apparatus including a storage device such as a memory, when an abnormality occurs in the memory, the image forming apparatus cannot be used. Therefore, it is desired to predict the abnormality of the memory.

A system is known to include a receiving unit, a determining unit, and a specifying unit. The receiving unit receives the number of times of writing to a memory included in a device and counter information of the device from the device. The determining unit determines an abnormality or probability of the abnormality based on the number of times of writing to the memory received by the receiving unit. The specifying unit specifies software causing the abnormality based on the counter information when the determining unit determines that there is the abnormality or probability of the abnormality. When the system detects the abnormality, the system can identify the cause of the abnormality.

In the related art including the system described above, the number of uses of a device is compared with a threshold value set in advance as a fixed value to predict an abnormality. However, since the timing of occurrence of an abnormality varies depending on various conditions such as the frequency of use, the abnormality cannot always be predicted appropriately by simply comparing the abnormality with the threshold value set in advance.

### SUMMARY

Embodiments of the present disclosure described herein provide a novel system that predicts an abnormality of a first device. The system includes processing circuitry. The processing circuitry calculates a first increment value of a number of uses of the first device included in a first apparatus, based on a first total number of uses of the first device within a first predetermined period. The processing circuitry determines an abnormality of the first device based on the first increment value.

Embodiments of the present disclosure described herein provide a novel method of predicting an abnormality of a first device. The method comprising: calculating a first increment value of a number of uses of the first device included in a first apparatus, based on a first total number of uses of the first device within a first predetermined period; and determining an abnormality of the first device based on the first increment value.

Embodiments of the present disclosure described herein provide a novel storage medium storing computer-readable program code that, when executed by a computer, causes the computer to perform a method of predicting an abnormality of a first device, the method comprising: calculating a first increment value of a number of uses of the first device included in a first apparatus, based on a first total number of uses of the first device within a first predetermined period; and determining an abnormality of the first device based on the first increment value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of hardware of an overall system according to an embodiment of the present disclosure;

FIGS. 2A and 2B are diagrams illustrating configurations of hardware included in apparatuses of the system illustrated in FIG. 1, according to an embodiment of the present disclosure;

FIG. 3 is a block diagram of software included in the system of FIG. 1, according to an embodiment of the present disclosure;

FIG. 4 is a diagram illustrating data stored in a device use history storage unit according to an embodiment of the present disclosure;

FIG. 5 is a flowchart of abnormality determination processing of a device, according to an embodiment of the present disclosure;

FIG. 6 is a flowchart of processing for searching for a similar apparatus, according to an embodiment of the present disclosure;

FIG. 7 is a diagram illustrating the determination of similarity between apparatuses, according to an embodiment of the present disclosure; and

FIGS. 8A, 8B, and 8C are graphs illustrating calculated increment values of apparatuses, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of the present disclosure with some embodiments. However, embodiments of the present disclosure are not limited to the embodiments described below. In the drawings referred below, like reference signs are used for the common elements, and the descriptions thereof are omitted as appropriate.

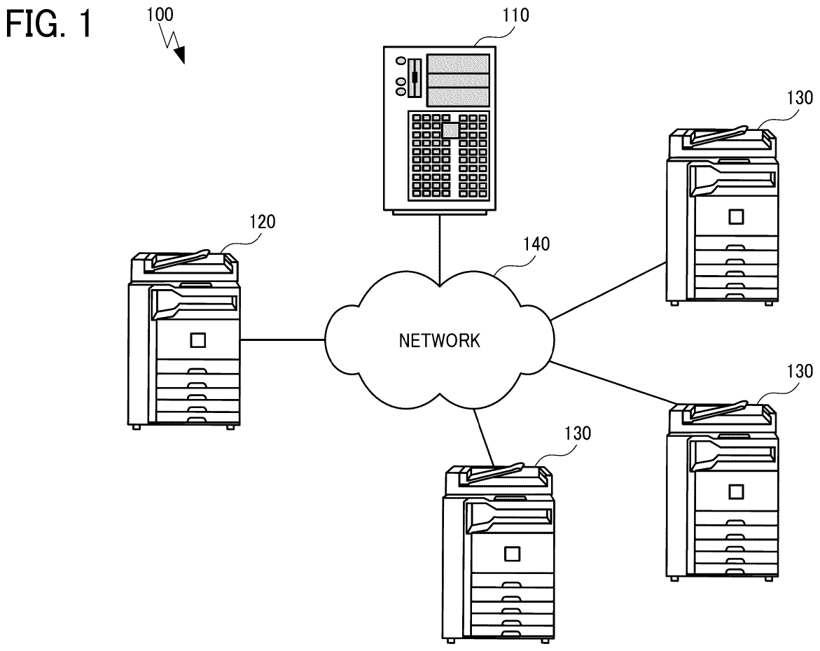

FIG. 1 is a diagram illustrating a schematic configuration of hardware of an overall system 100 according to an embodiment of the present disclosure. FIG. 1 illustrates a configuration example in which a server 110 and image forming apparatuses 120 and 130 are connected each other via a network 140 such as the Internet or a local area network (LAN). The number of image forming apparatuses 120 and the number of image forming apparatuses 130 included in the system 100 are not limited to those illustrated in FIG. 1, and the number of apparatuses included in the system 100 is not limited. The server 110 and image forming apparatuses 120 and 130 may be connected to the network 140 via a wired or wireless network.

The server 110 is an information processing apparatus that provides a service according to the present embodiment. The server 110 according to the present embodiment can acquire and analyze information about the apparatuses included in the system 100 to predict an abnormality of other apparatuses. The server 110 can notify a user or an administrator of the apparatus of a prediction result.

The image forming apparatuses 120 and 130 are information processing apparatuses that perform a print job in response to a print request. The image forming apparatuses 120 and 130 can convert a document read by a scan function into data, and copy or transmit the data to another apparatus.

In the embodiment described below, the image forming apparatus 120 is an apparatus that is a target for abnormality prediction, and the image forming apparatus 130 is an apparatus that is compared when the system 100 predicts an abnormality of the target apparatus. In the following description, the image forming apparatus 120 may be referred to as a target apparatus. The following embodiment is described with an example of predicting an abnormality of a hard disk included in an image forming apparatus that is a target apparatus. However, embodiments of the present disclosure are not particularly limited to such a configuration. The target apparatus may be an apparatus other than an image forming apparatus, or an abnormality of a device other than a storage device may be predicted.

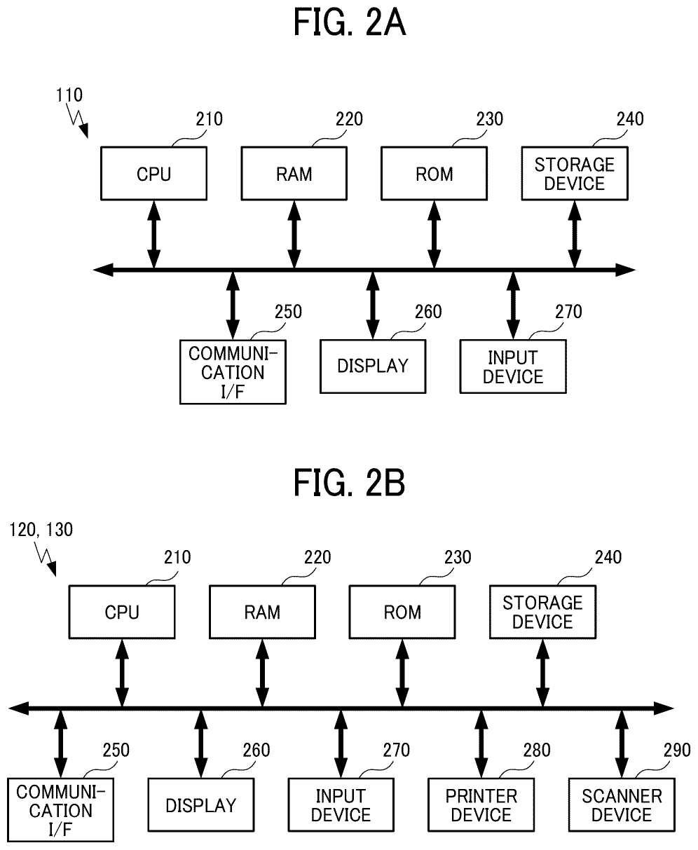

A description is given below of hardware configurations of the apparatuses described above. FIGS. 2A and 2B are diagrams illustrating configurations of hardware included in apparatuses of the system 100 according to an embodiment of the present disclosure. As illustrated in FIG. 2A, the server 110 includes a central processing unit (CPU) 210, a random-access memory (RAM) 220, a read-only memory (ROM) 230, a storage device 240, a communication interface (I/F) 250, a display 260, and an input device 270. As illustrated in FIG. 2B, the image forming apparatuses 120 and 130 each include a CPU 210, a RAM 220, a ROM 230, a storage device 240, a communication I/F 250, a display 260, an input device 270, a printer device 280, and a scanner device 290.

A description is given below of the server 110. The CPU 210 is a device that executes programs for controlling the operation of the server 110 and performs predetermined processing. The RAM 220 is a volatile storage device for providing an execution space for the programs to be executed by the CPU 210, and is used for storing and deploying programs and data. The ROM 230 is a non-volatile storage device for storing the programs and firmware executed by the CPU 210.

The storage device 240 is a readable and writable non-volatile storage device that stores, for example, an operating system (OS), various application programs, setting information, and various data for causing the server 110 to function. Examples of the storage device 240 include a hard disk drive (HDD) and a solid-state drive (SSD).

The communication I/F 250 connects the server 110 to the network 140, and allows the server 110 to communicate with other apparatuses via the network 140. Communication via the network 140 may be either wired communication or wireless communication, and various data can be transmitted and received using a predetermined communication protocol such as transmission control protocol/internet protocol (TCP/IP).

The display 260 is a device that displays, for example, various data and the state of the server 110 to the user. The display 260 may be, for example, a liquid crystal display (LCD). The input device 270 is a device for the user to operate the server 110. Examples of the input device 270 include a keyboard, a mouse, and a button. The display 260 and the input device 270 may be separate devices or a single device such as a touch screen display having both functions of the display 260 and the input device 270. The server 110 may not include the display 260 and the input device 270.

A description is given below of the hardware configuration of the image forming apparatuses 120 and 130. The CPU 210, the RAM 220, the ROM 230, the storage device 240, the communication I/F 250, the display 260, and the input device 270 of the image forming apparatuses 120 and 130 are the same as those of the server 110 described with reference to FIG. 2A, and a detailed description thereof is omitted.

The printer device 280 is a device configured to form an image on a sheet by a laser method or an inkjet method. The scanner device 290 is a device configured to read an image of a printed material and convert the image into data. For example, in the image forming apparatus 120, the scanner device 290 and the printer device 280 can cooperate with each other to copy a printed material.

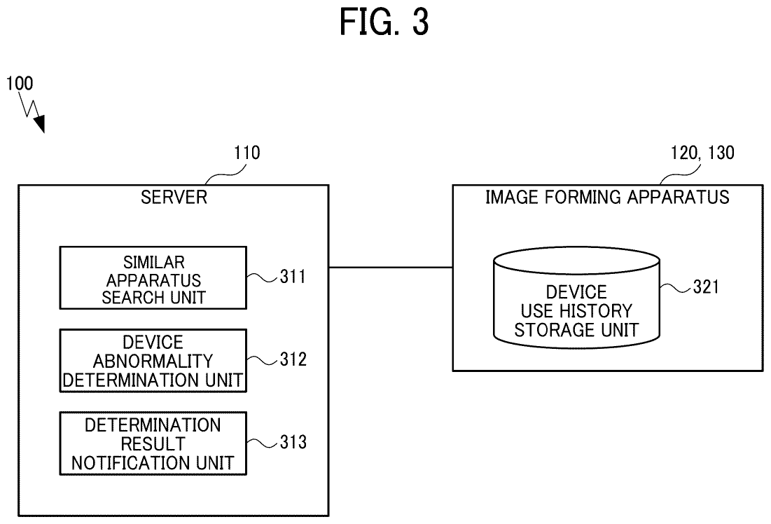

The hardware configuration included in each of the apparatuses of the system 100 according to the present embodiment has been described above. A description is given below of functional units implemented by the hardware, according to the present embodiment with reference to FIG. 3. FIG. 3 is a block diagram of software included in the system 100 according to an embodiment of the present disclosure.

As illustrated in FIG. 3, the server 110 includes functional units such as a similar apparatus search unit 311, a device abnormality determination unit 312, and a determination result notification unit 313. Each of the image forming apparatuses 120 and 130 includes a device use history storage unit 321.

The similar apparatus search unit 311 serves as a search unit in the present embodiment. The search unit searches for an apparatus similar to the target apparatus included in the system 100. The similar apparatus search unit 311 according to the present embodiment can compare the functions set in the target apparatus with the functions set in other apparatuses to extract an apparatus having many matching items as a similar apparatus.

The device abnormality determination unit 312 serves as a determination unit in the present embodiment. The determination unit predicts and determines an abnormality of a device (referred to as a first device) included in the target apparatus. The device abnormality determination unit 312 according to the present embodiment can predict an abnormality of the device of the target apparatus based on a usage status of a device (referred to as a second device) of the similar apparatus at the occurrence of an abnormality in the past and a usage status of the device of the target apparatus.

The determination result notification unit 313 serves as a notification unit in the present embodiment. The notification unit notifies the user of the target apparatus of the result of the determination determined by the device abnormality determination unit 312. The determination result notification unit 313 according to the present embodiment can notify, for example, the user or the administrator of the apparatus of the determination result via the network 140 by e-mail. Alternatively, the determination result notification unit 313 may notify the image forming apparatus 120, which is the target apparatus, of the determination result.

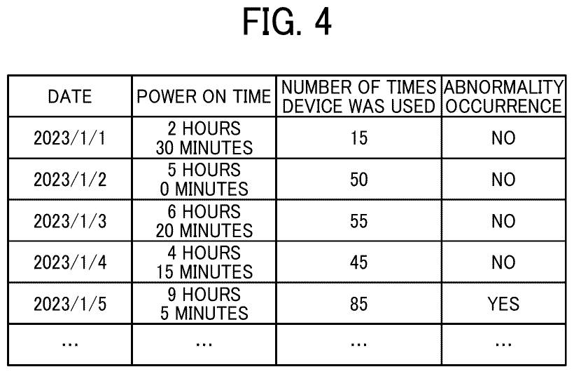

The device use history storage unit 321 serves a storage unit in the present embodiment. The storage unit controls the operation of the storage device 240, and stores the use history of the devices of the image forming apparatuses 120 and 130. A description is given below of the device use history storage unit 321 according to the present embodiment with reference to FIG. 4.

FIG. 4 is a diagram illustrating data stored in the device use history storage unit 321 according to an embodiment of the present disclosure. As illustrated in FIG. 4, the device use history storage unit 321 stores a table in which items “DATE,” “POWER ON TIME,” “NUMBER OF TIMES DEVICE WAS USED,” and “ABNORMALITY OCCURRENCE” are associated with each other.

The item “DATE” stores data of the date on which the device was used. The item “POWER ON TIME” stores the time during which the image forming apparatuses 120 and 130 were powered on the date. The item “NUMBER OF TIMES DEVICE WAS USED” stores data of the number of times the device was used on the date. For example, when the device is a hard disk, the number of times of writing to the hard disk can be stored in the item “NUMBER OF TIMES DEVICE WAS USED.” The item “ABNORMALITY OCCURRENCE” stores data indicating whether an abnormality has occurred in the device on the date.

Referring back to FIG. 3, the description is continued. The software blocks illustrated in FIG. 3 correspond to the functional units implemented by the CPU 210 executing programs according to the present embodiment to function the hardware devices. All the functional units illustrated in each of the embodiments according to the present disclosure may be implemented in software, or part or all of the functional units may be implemented as hardware that provides equivalent functions.

All of the functional units described above may not be included in a configuration illustrated in FIG. 3. For example, in another embodiment, the server 110 and the image forming apparatus 120 may cooperate with each other to implement each functional unit. In still another embodiment, the server 110 may include the device use history storage unit 321, and the image forming apparatus 120 may include at least one of the similar apparatus search unit 311, the device abnormality determination unit 312, and the determination result notification unit 313.

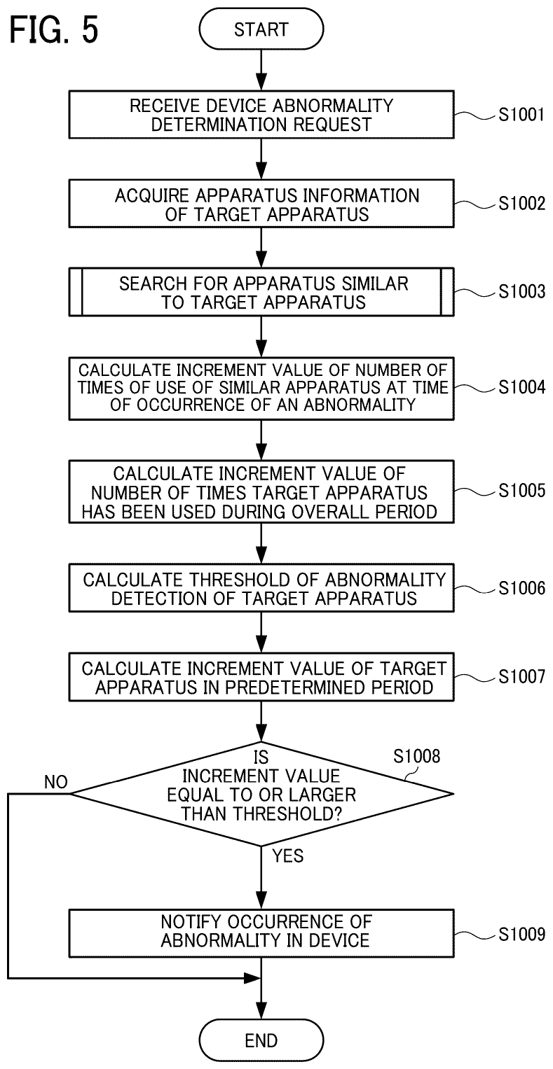

A description is given below of a process executed by the functional units described above with reference to FIG. 5. FIG. 5 is a flowchart of an abnormality determination process of a device, according to an embodiment of the present disclosure. The system 100 starts the process from step S1000.

In step S1001, the server 110 receives a device abnormality determination request. In the present embodiment, the processing of step S1001 may not be executed. For example, the abnormality determination process may be periodically executed at a preset timing even when the device abnormality determination request is not received.

Subsequently, in step S1002, the similar apparatus search unit 311 acquires apparatus information of the target apparatus to search for a similar apparatus. The apparatus information acquired in step S1002 includes, for example, an identification (ID) for identifying an apparatus and various types of setting information but is not particularly limited thereto.

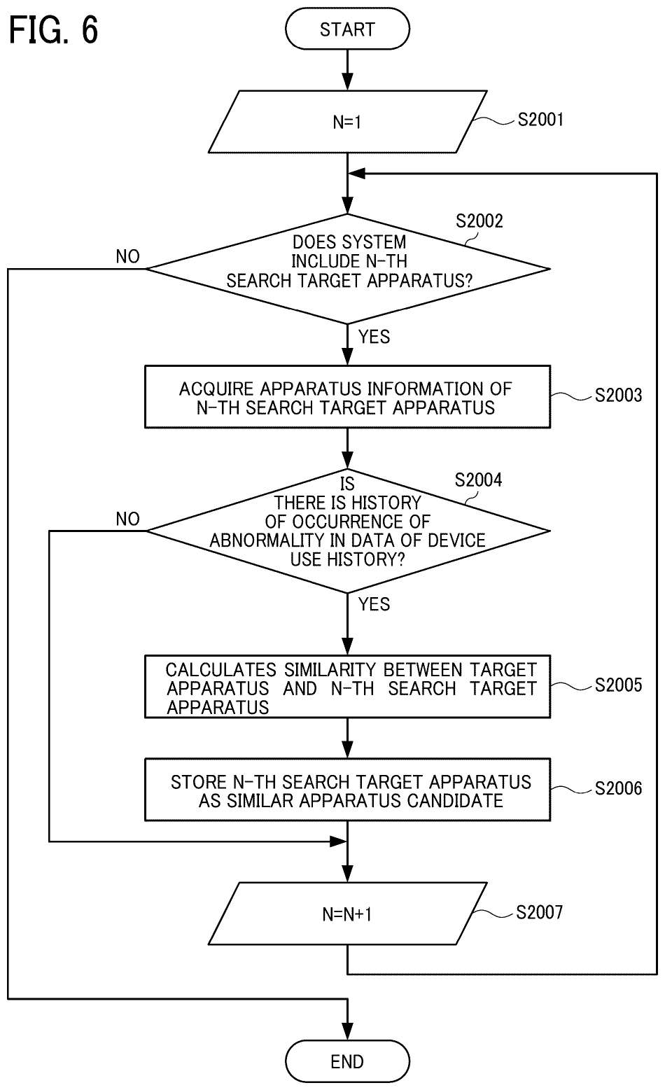

In the subsequent step S1003, the similar apparatus search unit 311 searches for an apparatus similar to the target apparatus among the image forming apparatuses 130 included in the system 100 based on the acquired apparatus information of the target apparatus. A description is given below of a process for searching for a similar apparatus with reference to FIG. 6. FIG. 6 is a flowchart of the process for searching for a similar apparatus, according to an embodiment of the present disclosure.

The similar apparatus search unit 311 starts the process for searching from step S2000. Each processing illustrated in FIG. 6 corresponds to step S1003 in FIG. 5. The similar apparatus search unit 311 sets a variable n to one in step S2001. Subsequently, in step S2002, the similar apparatus search unit 311 branches the process depending on whether the system 100 includes the n-th search target apparatus. When the system 100 does not include the n-th search target apparatus (NO in step S2002), the similar apparatus search unit 311 proceeds the process to step S2008 to end the process. When the system 100 includes the n-th search target apparatus (YES in step S2002), the similar apparatus search unit 311 proceeds the process to step S2003.

In step S2003, the similar apparatus search unit 311 acquires the apparatus information of the n-th search target apparatus. The acquired apparatus information includes history data stored in the device use history storage unit 321 of the image forming apparatus 130, an ID for identifying the apparatus, and various setting information.

Subsequently, in step S2004, the similar apparatus search unit 311 branches the process depending on whether data of the device use history includes a history of occurrence of an abnormality. When the data of the device use history does not include a history of occurrence of an abnormality (NO in step S2004), the similar apparatus search unit 311 proceeds the process to step S2007. When the data of the device use history includes a history of occurrence of an abnormality (YES in step S2004), the similar apparatus search unit 311 proceeds the process to step S2005.

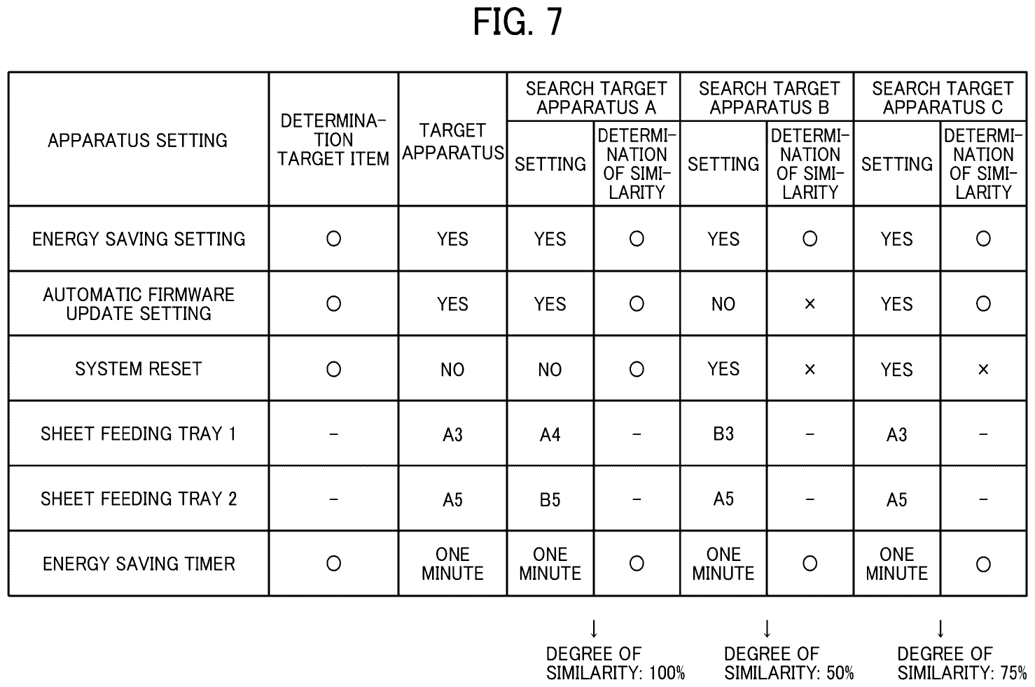

In step S2005, the similar apparatus search unit 311 calculates the similarity between the target apparatus and the n-th search target apparatus. The similar apparatus search unit 311 compares the setting information acquired in step S1002 of FIG. 5 with the setting information acquired in step S2003 to calculate the similarity in step S2005. A description is given below of the calculation of the similarity of the apparatuses based on the comparison of the setting information with reference to FIG. 7. FIG. 7 is a diagram illustrating the determination of similarity between apparatuses, according to an embodiment of the present disclosure.

FIG. 7 is a table in which the setting information of the target apparatus of the abnormality determination and multiple search target apparatuses are summarized. The similar apparatus search unit 311 according to the present embodiment searches for and determines a similar apparatus based on the comparison of setting information. However, the table illustrated in FIG. 7 may not be generated. In other words, the table of FIG. 7 is presented for the sake of convenience.

In the present embodiment described below, the similar apparatus search unit 311 determines the similarity based on the item of apparatus setting that is set to a determination target item. In the example of FIG. 7, the items “ENERGY SAVING SETTING”, “AUTOMATIC FIRMWARE UPDATE SETTING”, “SYSTEM RESET”, and “ENERGY SAVING TIMER” of the apparatus setting are the determination target items. In the present embodiment described below, the determination target item can be an item that is possibly related to an abnormality of the device. On the other hand, the apparatus setting having a small relevance to the device abnormality, for example, sheet feeding trays of the image forming apparatuses 120 and 130 as illustrated in FIG. 7 can be excluded from the target of the similarity determination.

In the example illustrated in FIG. 7, the target apparatus is set to “ON” for the item “ENERGY SAVING SETTING,” “ON” for the item “AUTOMATIC FIRMWARE UPDATE SETTING,” “OFF” for the item “SYSTEM RESET,” and “one minute” for the item “ENERGY SAVING TIMER”.

On the other hand, in the search target apparatus A, the item “ENERGY SAVING SETTING” is set to “ON”, the item “AUTOMATIC FIRMWARE UPDATE SETTING” is set to “ON”, the item “SYSTEM RESET” is set to “OFF”, and the item “AUTOMATIC FIRMWARE UPDATE SETTING” is set to “one minute”. Accordingly, since the settings of the determination target items are all the same as the settings of the target apparatus, the similarity of the search target apparatus A is calculated as 100%.

In the search target apparatus B, the item “ENERGY SAVING SETTING” is set to “ON”, the item “AUTOMATIC FIRMWARE UPDATE SETTING” is set to “OFF”, the item “SYSTEM RESET” is set to “ON”, and the item “ENERGY SAVING TIMER” is set to “one minute”. As a result, since two of the four determination target items are the same as the settings of the target apparatus, the similarity of the search target apparatus B is calculated as 50%.

In the search target apparatus C, the item “ENERGY SAVING SETTING” is set to “ON”, the item “AUTOMATIC FIRMWARE UPDATE SETTING” is set to “ON”, the item “SYSTEM RESET” is set to “ON”, and the item “ENERGY SAVING TIMER” is set to “one minute”. As a result, since three of the four determination target items are the same as the settings of the target apparatus, the similarity of the search target apparatus C is calculated as 75%.

Referring back to FIG. 6, the description is continued. After the similarity is calculated in step S2005, the n-th search target apparatus is stored as a candidate for similar apparatus in step S2006. Subsequently, in step S2007, the value of the variable n is incremented. Then, the similar apparatus search unit 311 returns the process to step S2002, and the process described above is repeated for all the image forming apparatuses 130 included in the system 100.

The similar apparatus search unit 311 can determine an apparatus having the highest similarity among the candidates for similar apparatus stored in step S2006 as a similar apparatus. As a result, in the example illustrated in FIG. 7, the search target apparatus A is determined as a similar apparatus.

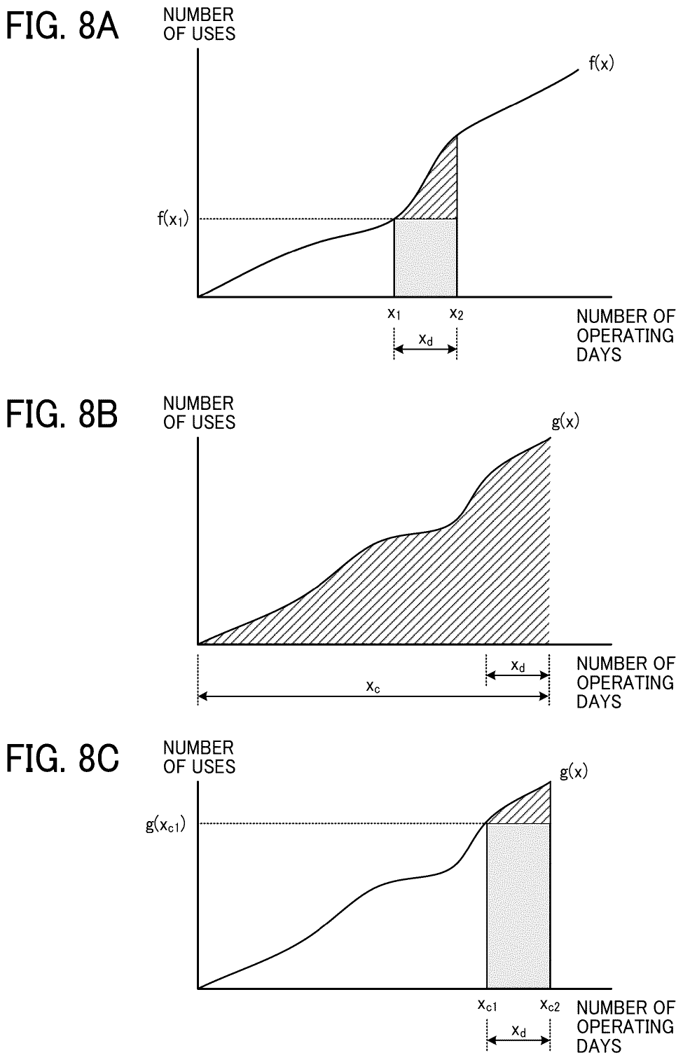

Referring back to FIG. 5, the description is continued. After the similar apparatus search unit 311 determines the similar apparatus by the process illustrated in FIG. 6 corresponding to step S1003, the similar apparatus search unit 311 proceeds the process to step S1004. In step S1004, the similar apparatus search unit 311 calculates an increment value of the number of uses of the similar apparatus at the occurrence of an abnormality in the past in the similar apparatus. A description is given below of the increment value calculated in the present embodiment with reference to FIG. 8. FIGS. 8A, 8B, and 8C are graphs illustrating the increment values of apparatuses calculated, according to an embodiment of the present disclosure.

FIG. 8A is a graph illustrating the number of operating days and the number of uses in a similar apparatus, and the graph is given by f(x). In FIG. 8A, the horizontal axis (X-axis) represents the number of operating days, and the vertical axis (Y-axis) represents the cumulative number of uses. In the example illustrated in FIG. 8A, it is assumed that an abnormality has occurred in the similar apparatus at the time of x2 in the past. The increment value (referred to as a second increment value) of the similar apparatus in the present embodiment corresponds to the size of the region indicated by hatching in FIG. 8A. Accordingly, an increment value D₁₃₀ may be calculated by, for example, the following Equation 1 including integration.

$$Equation 1$$

$${D}_{130} = {\int }_{{x}_{1}}^{{x}_{2}} f ( x ) - f ( {x}_{1} ) \times {x}_{d} \qquad ( 1 )$$

The first term on the right side of Equation 1 is obtained by integrating f(x) over the period from a point in time x₁ to a point in time x₂. The point in time x₁ is a time point traced back from the point in time x₂ by an arbitrary predetermined period. The point in time x₂ is a time point when an abnormality is occurred. The arbitrary predetermined period is represented by x_{d}. Accordingly, the first term of the right side of Equation 1 indicates the size of the region obtained by combining the region indicated by hatching in FIG. 8A and the rectangular region indicated by a dark color in FIG. 8A.

The second term on the right side of Equation 1 is obtained by multiplying the number of uses at the point in time x₁ by the predetermined period x_{d}. Accordingly, the second term of the right side of Equation 1 indicates the size of the rectangular region indicated by the dark color in FIG. 8A.

As a result, the increment value D₁₃₀, which corresponds to the region indicated by hatching in FIG. 8A, is given by Equation 1 described above. The increment value D₁₃₀ may be calculated by a method other than Equation 1, and may be calculated by, for example, obtaining the total number of uses of a device within the predetermined period x_{d}. In this case, obtaining the total number of uses of the device is a broader concept of integration and can include integration.

Referring back to FIG. 5, the description is continued. After the increment value of the similar apparatus is calculated by Equation 1 described above in step S1004, the process proceeds to step S1005. In step S1005, the increment value of the number of uses of the target apparatus in all the periods is calculated. A description is given below of the increment value of the number of uses of the target apparatus, with reference to FIG. 8B.

FIG. 8B is a graph illustrating the number of operating days and the number of uses in the target apparatus, and the graph is given by g(x). In FIG. 8B, the horizontal axis (X-axis) represents the number of operating days, and the vertical axis (Y-axis) represents the cumulative number of uses. A value D₁₂₀ obtained by normalizing the total number of uses of the target apparatus (referred to as a normalized total value) may be calculated by, for example, the following Equation 2 including integration.

$$Equation 2$$

$${D}_{120} = {\int }_{0}^{{x}_{c}} g ( x ) \times \frac{{x}_{d}^{2}}{{x}_{c}^{2}} \qquad ( 2 )$$

A period x_{c} indicates a period from the start of use of the target apparatus to the present. The factor of x_{d}²/x_{c}² at the end of the right side of Equation 2 is used to normalize the value in accordance with the increment value of the similar apparatus for the calculation of a threshold described later. In other words, the normalized total value D₁₂₀ of the target apparatus is obtained by normalizing the region indicated by hatching in FIG. 8B, which is calculated by the first factor including integration, in accordance with the predetermined period in the calculation of the increment value of the similar apparatus. The normalized total value D₁₂₀ may be calculated by a method other than Equation 2 and may be calculated, for example, by multiplying the total number of uses within the period x_{c}, which is a period from the start of use of the device to the present, by the last factor on the right side of Equation 2. In this case, obtaining the total number of uses of the device can be regarded as a broader concept of integration and can include integration.

Referring back to FIG. 5, the description is continued. After the increment value of the target apparatus is calculated by Equation 2 described above in step S1005, the process proceeds to step S1006. In step S1006, a threshold of an abnormality detection of the target apparatus is calculated. A threshold D_{TH} of the abnormality detection is calculated by the following Equation 3.

$$Equation 3$$

$${D}_{TH} = \frac{{D}_{130} + {D}_{120}}{2} \qquad ( 3 )$$

As illustrated in Equation 3 described above, the threshold D_{TH} can be the average value of increment value D₁₃₀ and the normalized total value D₁₂₀. For example, if the threshold is simply set to the increment value of the similar apparatus alone, the target apparatus may not be detected as an abnormality even when the increment of the number of uses of the target apparatus is large. Accordingly, when the threshold is set in consideration of the average use frequency of the target apparatus, a predictor of the abnormality can be detected by the threshold suitable for the target apparatus, and thus more appropriate abnormality detection can be performed.

Subsequently, in step S1007, an increment value D₁₂₀′ of the target apparatus in the predetermined period x_{d} is calculated. A description is given below of the increment value D₁₂₀′ of the target apparatus in the predetermined period x_{d}, with reference to FIG. 8C.

FIG. 8C is a graph illustrating the number of operating days and the number of uses in the target apparatus, and the graph is given by g(x). In FIG. 8C, the horizontal axis (X-axis) represents the number of operating days, and the vertical axis (Y-axis) represents the cumulative number of uses. The increment value D₁₂₀′ (referred to as a first increment value) of the target apparatus in the present embodiment corresponds to the size of the region indicated by hatching in FIG. 8C. Accordingly, the increment value D₁₂₀′ may be calculated, for example, by the following Equation 4 including integration.

$$Equation 4$$

$${D}_{120}^{′} = {\int }_{{x}_{c 1}}^{{x}_{c 2}} g ( x ) - g ( {x}_{c 1} ) \times {x}_{d} \qquad ( 4 )$$

In Equation 4, x_{c2} illustrated in FIG. 8C indicates the present point in time, and x_{c1} illustrated in FIG. 8C is a point in time traced back from the present point in time x_{c2} by the predetermined period x_{d}. Accordingly, a hatching region indicating the increment value D₁₂₀′ is calculated in the same manner as in Expression 1. In other words, the increment value D₁₂₀′ can be calculated by the difference between the size of the integral term and the size of the rectangular region indicated by the dark color in FIG. 8C, as expressed by Equation 4 described above. The increment value D₁₂₀′ may be calculated by a method other than Equation 4, and may be calculated by, for example, obtaining the total number of uses of the device within the predetermined period x_{d}. In this case, obtaining the total number of uses of the device can be regarded as a broader concept of integration and can include integration.

Referring back to FIG. 5, the description is continued. After the increment value D₁₂₀′ of the target apparatus in the predetermined time is calculated in step S1007, the process proceeds to step S1008. In step S1008, the similar apparatus search unit 311 branches the process depending on whether the increment D₁₂₀′ calculated in step S1007 is equal to or larger than the threshold D_{TH} calculated in step S1006. When the increment D₁₂₀′ is less than the threshold D_{TH} (NO in step S1008), the similar apparatus search unit 311 proceeds the process to step S1010 to end the process.

On the other hand, when the increment D₁₂₀′ is equal to or larger than the threshold D_{TH} (YES in step S1008), the similar apparatus search unit 311 proceeds the process to step S1009. In such a case, since the usage amount of the device of the target apparatus in the predetermined period increases similarly to the case where the abnormality has occurred in the similar apparatus in the past, the probability that the abnormality occurs in the target apparatus is also high. Accordingly, in step S1009, the probability of an occurrence of an abnormality in the device is notified. The notification in step S1009 can be performed, for example, via the network 140. After that, the similar apparatus search unit 311 ends the process in step S1010.

According to the process illustrated in FIG. 5, since the similar apparatus search unit 311 can appropriately detect a predictor of the occurrence of an abnormality in a device, the target apparatus can be stably operated. In particular, the threshold for determining abnormality detection can be set in consideration of the use status of the apparatus, and thus, a predictor of the occurrence of an abnormality can be detected by the threshold suitable for each apparatus. In particular, when the total number of uses within a predetermined period is used, a predictor of the occurrence of an abnormality can be determined based on results in which the number of uses is temporally averaged, regardless of the occurrence of a specific event. In other words, for example, in a case where there are a device having a large number of uses and a device having a small number of uses in the same time interval, it is determined that the former device has a higher probability of the occurrence of the abnormality. As a result, the process according to the present embodiment, it is possible to perform the detection of an abnormality predictor that reflects the actual usage status of the device more.

The process of the embodiment described above with reference to FIG. 5 may not be executed by the server 110 alone. For example, the image forming apparatus 120, which is the target apparatus, may perform some or all of the process. For example, the server 110 may transmit the calculated threshold D_{TH} to the image forming apparatus 120, and the image forming apparatus 120 may calculate the increment value D₁₂₀′ of the image forming apparatus 120 in a predetermined period and compare the increment value D₁₂₀′ with the threshold D_{TH} transmitted by the server 110.

According to the embodiments of the present disclosure described above, a system, a method, and a program for predicting an abnormality of a device with high accuracy can be provided.

Each of the functions of the embodiments of the present disclosure described above can be implemented by a device-executable program written in, for example, C, C++, C#, and Java®. The program according to embodiments of the present disclosure can be stored in a device-readable recording medium to be distributed. Examples of the recording medium include a hard disk drive, a compact disc-read-only memory (CD-ROM), a magneto-optical disk (MO), a digital versatile disk (DVD), a flexible disk, an electrically erasable programmable read-only memory (EEPROM®), and an erasable programmable read-only memory (EPROM). The program can be transmitted over a network in a form with which another computer can execute the program.

Although the present disclosure has been described above with reference to the embodiments, the present disclosure is not limited to the above-described embodiments. Within the range of embodiments that can be estimated by skilled person, those exhibiting functions and effects of the present disclosure are included in the scope of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A system for predicting an abnormality of a first device, the system comprising:
processing circuitry configured to:
calculate a first increment value of a number of uses of the first device included in a first apparatus, based on a first total number of uses of the first device within a first predetermined period; and
determine an abnormality of the first device based on the first increment value.

2. The system according to claim 1, wherein the processing circuitry is further configured to:
calculate a second increment value of a number of uses of a second device included in a second apparatus similar to the first apparatus, based on a second total number of uses of the second device within a second predetermined period of time until a time at which an abnormality has occurred in the second device; and
compare the first increment value with the second increment value to determine an abnormality of the first device.

3. The system according to claim 2, wherein the processing circuitry is configured to:
calculate a normalized total value of the number of uses of the first device, based on normalization of a third total number of uses of the first device from a start of use of the first device;
calculate a threshold based on the normalized total value and the second increment value; and
notify the abnormality of the first device when the first increment value is equal to or larger than the threshold.

4. The system according to claim 3, wherein the processing circuitry is configured to calculate the threshold as an average value of the normalized total value and the second increment value.

5. The system according to claim 2,
wherein the processing circuitry is configured to compare setting information of the first apparatus with setting information of a plurality of other apparatuses to search for the second apparatus similar to the target apparatus.

6. The system according to claim 1,
wherein the processing circuitry is configured to determine the abnormality of the first device in response to a determination request.

7. The system according to claim 1,
wherein the processing circuitry is configured to determine the abnormality of the first device at a preset time.

8. A method of predicting an abnormality of a first device, the method comprising:
calculating a first increment value of a number of uses of the first device included in a first apparatus, based on a first total number of uses of the first device within a first predetermined period; and
determining an abnormality of the first device based on the first increment value.

9. A non-transitory storage medium storing computer-readable program code that, when executed by a computer, causes the computer to perform a method of predicting an abnormality of a first device, the method comprising:
calculating a first increment value of a number of uses of the first device included in a first apparatus, based on a first total number of uses of the first device within a first predetermined period; and
determining an abnormality of the first device based on the first increment value.
